(19) United States
(12) Patent Application Publication
(10) Pub. No.: US 2002/0089166 A1
(43) Pub. Date: Jul. 11, 2002

(54) Binder view pocket

(76) Inventor: David C. Schwartz, Southboro, MA (US)

Correspondence Address: David C, Schwartz, P.O. Box 109, Southboro, MA, 01772, US

(21) Appl. No.: 10/006,726

(22) Filed: Dec. 3, 2001

Related U.S. Application Data
(63) Continuation of application No. 08/763,551, filed on Dec. 10, 1996, now abandoned.
Application No. 08/763,551 is a continuation of application No. 08/197,217, filed on Feb. 16, 1994, now abandoned.

(51) Int. Cl. B42D 1/00; B42D 5/00

(52) U.S. Cl. 281/15.1

(57) ABSTRACT

This invention relates to pockets for holding a single or a small batch of sheets of paper, and particularly to the construction of an enclosure which provides “direct write” storage and access for a top leaf enclosed therein, where one entry lip of the pocket is on a border of one edge of the pocket forming a “book edge” for retaining the margin side of a leaf, and dual corner tab pockets are on the opposing edge's corners for retaining one or both corners opposing the margin edge of said leaf, thereby allowing the secure entry of one or more leaves therein, allowing the encoding of the sequence position of the leaf when placed therein as to a place in either “last in first seen” or “last in last seen” position, offering secure sequential viewing along the book edge when the ends secured under the corner tabs are both free, and providing for direct writing on the surface of the top leaf when the pocket is laid face up

### BACKGROUND OF THE INVENTION

This application is a continuation of commonly assigned U.S. patent application Ser. No. 08/763,551 now abandoned, which is a continuation of commonly assigned U.S. patent application Ser. No. 08/197,217, filed Feb. 16, 1994, now abandoned.

This invention relates to pockets for holding a single or a small batch of sheets of paper, and particularly to the construction of an enclosure which provides “direct write” storage and access for a top leaf enclosed therein, where one entry lip of the pocket is on a border of one edge of the pocket forming a “book edge” for retaining the margin side of a leaf, and dual corner tab pockets are on the opposing edge's corners for retaining one or both corners opposing the margin edge of said leaf, thereby allowing the secure entry of one or more leaves therein, allowing the encoding of the sequence position of the leaf when placed therein as to a place in either “last in first seen” or “last in last seen” position, offering secure sequential viewing along the book edge when the ends secured under the corner tabs are both free, and providing for direct writing on the surface of the top leaf when the pocket is laid face up.

Small count multi-sheet pockets have been available which are formed with “picture tab” corners. Preferably for storing single sheets, small batches of sheets may be stored within them. In these types of pockets, the leaf is tucked under the corners and retained. This technique is used for pictures in a photo album. In addition, pockets with a strip edge on either side are used with similar success for holding single or small batches of sheets as seen on the panel of a book cover used as a menu or for retaining note cards, typically in a pocket size format. These pockets do not provide a book edge in combination with two corner tab pockets, and consequentially cannot provide for both secure sequential turning and the capability for placement marking as to last in first seen or last in last seen.

The pocket according to the invention provides a secure binding edge on the margin side of the leaf that is an elongated band that spans t h e complete margin of the host leaf and is enclosed to provide secure storage along that edge as well as to allow the temporary attachment of multiple leaves when the opposing edges are free and the leaves are turned as a mini-book. The dual corners provide secure storage for the leaf when both corners opposing the margin are enclosed thereunder, and offers a way to mark the chronological relationship of a leaf to a batch of leaves when one corner is left untucked. The untucked “state” is a sign that the leaf has been put in the order “last in first seen” and the dual tucked position is a sign that the leaves are all in chronological order “last in last seen.” Of course, the opposite encoding can be used where one always stacks for the objective of “last in last seen” and always tucks both corners. Any of the currently known pocket styles can support this as well. If, however, one wants to always keep the stack referential in chronological order of capture, and this is the intended semi-permanent state of storage of a leaf, and uses the pocket configuration for only temporarily holding pages out of order, in a temporary state(one corner untucked) until properly placed in chronology(marked by being placed below the batch of leaves with both corners tucked) then a pocket of the kind in this invention is necessary. The advantage offered by the combination of bindings further ensures that all the leaves are secure from adhoc dislocation, whether encoded and placed in “temporary” or semi-permanent holding position. Unbinding the upper corner or lower corner leaves that corner of the leaf or leaves free to “peel”. Unbinding both tucked corners allows for mini-book turning of all of the leaves which are each held along the “book binding edge”. The top surface can sustain direct writing on the entire writing surface thereof. A small batch, secure locking pocket, with multiple sheet interrogation at a corner, and further having direct write on for the top leaf has been unavailable.

The advantage of the bookbinding pocket of this invention is the ability to construct the device on high speed folder/gluer equipment. Forming the pocket where the glue lines are parallel and where the glue on both parallel edges can be applied a the same location in the production line, at the same time, on opposing edges is an advantage in cost reduction to the production. The pattern employed in this configuration minimizes material waste while permitting the formation of the opposing pocket sets without requiring that the pocket pattern be flipped over.

The advantage of sealing the portion of the binding edge where a pattern of removable holes is positioned permits the formation of a removable hole with the added strength of the bonded material surrounding it. This lets the hole be reused many times without fatiguing.

A slice cut in the margin band permits one half page flipping forward of a stack of retained leaves while retaining the page turning property of the original book binding edge.

The use of slots to hold a refillable label strip permits relabeling of the pocket and reuse without permanently marking the pocket as would the corner tab label insert or the provision of a corner with a cut out so that the top sheet could be labeled and viewed through the cut out.

Forming the book binding pocket with a window adapter or integrally sectioning out a portion of a window adapter from the pocket itself allows the pocket to be attached to a number of different host products.

### SUMMARY OF THE INVENTION

The invention therefore relates to pockets, and in particular to a pocket capable of grouping a single leaf or a small batch of leafs, where the binding edge for holding the margin is an enclosed band of a length substantially the length of the margin of the leaf to be held, and the opposing corners of the pocket provide tabs for tucking the leaf in place, thereby preventing the leaves from being dislodged in an adhoc manner.

The invention further relates to the construction of a pocket of the above kind where the margin edge of the pocket has a binding means formed with a cut pattern, typically a pattern of holes, to allow one or more of the pockets according to the invention to be combined into a set.

The invention relates to the construction of a pocket where the binding edge that holds the margin is a band of suitable length to securely hold one or more leaves in place so as to permit mini-book turning and shuffling of the leafs one with respect to the other, when the opposing corners of the leaves are all free.

In particular, the invention relates to the construction of a pocket according to the invention, formed from one sheet of flexible material such as card stock, where the cut and fold pattern of the card stock allows for the formation of the complete pocket by a sequence of folds and a sealing step.

The invention relates to the construction of pockets of this kind from any flexible material such as spun olefin(tyvek™/Dupont), polypropelene, vinyl, paper, plastic of other varieties or like and similar substances having a stiffness property ranging from flexible to subtly rigid and being bondable by way of adhesive tabs, electrical bonding, heat sealing, specialty gluing, stapling, and the like.

It is a further object of this invention to provide a pattern of material for forming the pocket which requires the minimum amount of material while requiring only two parallel folding steps and a single parallel sealing step without having to flip the pocket over.

An additional object of this invention is to provide a reinforced binding edge where a reusable, I.e. Reinsertable hole pattern may be placed so that the reinforced binding provides extra life to the insert pattern.

Additionally, folding patterns which hide the tabs are provided as well as a book binding edge that permits ½ page forward flipping. Ways to label the pocket without writing directly on the pocket are also provided for.

The formation of a book binding pocket as an attachable pop out pocket is also provided for. This configuration would be particularly useful for attaching a ream of loose sheets of paper to a host book. The individual top page would also be able to be pulled out, turned over, and reinserted into the pocket, thereby allowing the individual sheets to be written on both sides.

### BRIEF DESCRIPTION OF THE DRAWINGS

The above and other objects and advantages of the invention will be apparent from consideration of the following drawings taken to conjunction with the detailed description following these drawings, in which like reference characters are used to refer to like parts and in which:

FIG. 1 Shows the front view of a pocket with three hole punches on the the binding edge, and dual corner pockets for securely holding a leaf, and further shows a leaf peeled at both corners.

FIG. 2 Shows the front view of the pocket with the leaf removed.

FIG. 2a Shows the front view of the pocket with the leaf removed where the pocket is shown to have alternative forms of mini-booking secondary binding structures.

FIG. 2b Shows an alternative corner formed from an elastic band with two clips inserted into respective holes diagonally punched at a distance substantially the length of the elastic band.

FIG. 3 Shows an unfolded view of one form of construction having dual corner tab portions which combine to form a corner pocket and having a band formed from a section of material spanning the height of the base panel and having tab portions and a symmetrical hole pattern for attachment to a host binding.

FIG. 3a Shows an alternative corner construction with a band formed by a strip which is folded over and adhesive attached to the edge of the base panel.

FIG. 4 Shows the unfolded part of one form of construction of the binding edge of the pocket for holding the margin edge of the leaf to be held therein, where the symmetrical hole portion is adhesively attached one side to the other and the band is formed adjacent thereto.

FIG. 5 Shows a perspective view of a host binder in which the pocket according to the invention is shown inserted between the covers of an encasing pocket.

FIG. 6 shows a pattern of a bookbinding pocket that can be formed by a series of steps including a parallel fold, a parallel glue, and subsequent parallel fold requiring only one bump and turn but no flip over.

FIG. 6a shows the result of the first parallel fold and highlights the parallel glue and second parallel fold.

FIG. 6b shows the resulting pocket after the second parallel fold.

FIG. 7 shows a pattern for a reinforcable book binding edge with a reusable hole pattern. The cut out arrow indicates how to remove or insert.

FIG. 7a shows the pattern of FIG. 7 folded over and bonded to form a reinforced hole edge. The pocket portion of the binding edge is retained.

FIG. 8 shows a pattern for forming a book binding pocket where the tab edges are hidden and where a minimum of tabs are used.

FIG. 8a shows the pattern of FIG. 8 where the base panel is flipped over on top of the “picture frame” portion of the pocket.

FIG. 8b shows the pattern of FIG. 8a after the two fold and glue steps.

FIG. 9 shows an alternative pattern for forming a book binding pocket where the tab edges are hidden and where a minimum number of tabs are used.

FIG. 9a shows the pattern of FIG. 9 where the base panel is flipped side ways onto the “picture frame” portion of the pocket.

FIG. 9b shows the pattern of FIG. 9A after the two fold and glue steps.

FIG. 10 shows a book binding pocket having a slit middle there in.

FIG. 11 shows a book binding pocket having a strip for labeling insertable into the margin portion of the book binding pocket.

FIG. 12 shows a corner tab having a cut out retaining slot and a cut out marking slot.

FIG. 13 shows an insert for a corner like that in FIG. 12 where a lock tab is complemented by a label tab portion.

FIG. 14 shows a corner tab where there is a cut out portion for permitting the direct marking of the top sheet without having to write on the pocket itself.

FIG. 16 shows a book pocket having a construction similar to that of FIG. 6, integrally formed with a mounting support surface, and orientation panel, and an optional extension panel.

FIG. 16a shows the device perspective drawing of FIG. 16 when the pattern is “assembled”.

FIG. 17 shows an alternative to the construction of FIG. 16 where the orientation panel is formed from a portion of the base panel.

FIG. 17a shows the device perspective drawing of FIG. 17 when the pattern is “assembled”.

### DETAILED DESCRIPTION OF THE INVENTION

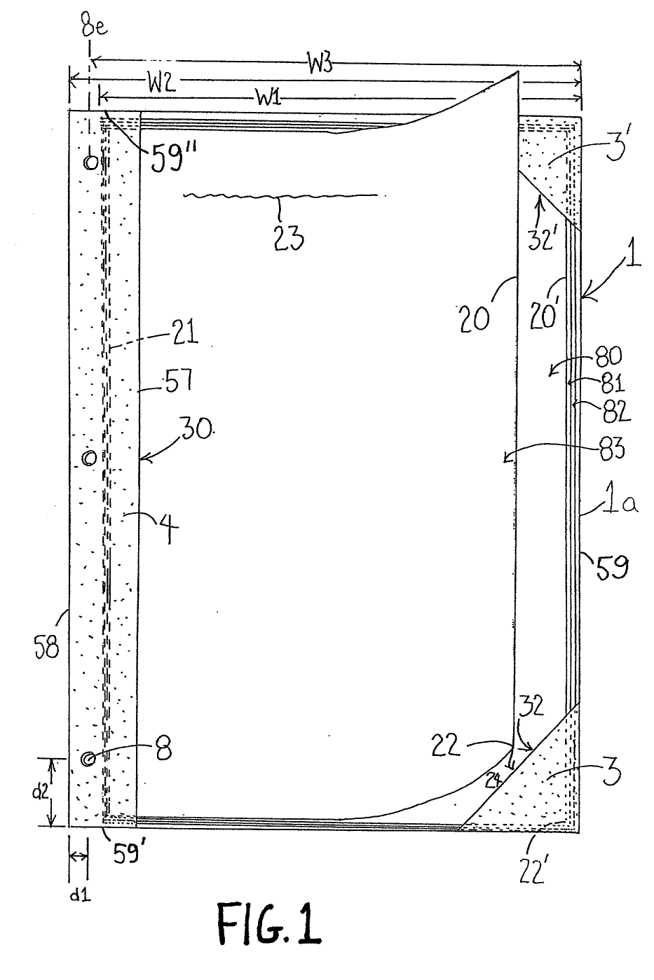

FIG. 1 Shows the front view of a pocket,1, with three holes, 8, punched on the the binding edge having band, 4, and dual corner pockets 32 and 32′ formed by tab corners,3 and 3′, for securely holding a leaf 20 and further shows the leaf, 20, peeled at both corners. Said band 4 is forms a pocket 30 where said band has opposing top and bottom ends, 59′ and 59″, and opposing edges, an inner edge 57 and an outer edge 58, with the top and bottom ends and the outer edge being attached to base panel 1a, thereby leaving edge 57 unattached to form a pocket, the book binding structure. The corner binding edge, 59 has two pockets formed thereon, a top corner pocket 3′ and a bottom corner pocket 3. Each triangular corner pocket has two edges attached to the base panel and a free lip 32′ and 32 which forms the pocket structure. Corner 22 is shown by motion 24 to be able to be alternatively tucked under corner pocket 32 for “encoding” as to it's state of capture. In the preferred use, when one or more leaves have both their corners free and only the margin is held below band 4, the leaves are in mini-book mode for sequential visual scanning, when all leaves have their corners tucked, then the leaves are in chronological sequence, i.e. last in last seen, and when a leaf or leaves have the upper corner untucked, it is in a temporary state of last in first seen and is awaiting shuffling to the bottom of the batch, into last in last seen position. The other leafs of the batch, are below and edge 20′, for example has both corners tucked. So, leaves 80,81, and 82 are in chronological order, last in last seen, and leaf 83 is about to be placed in last in first seen position, with it's bottom corner tucked and it's top corner untucked. Edge 58 is the “book edge” and has a band 4, for securing a batch of leaves. The leaf has a width W1 which is shorter than the pocket width W2 by an amount which permits the formation of a binding region where, holes 8, are formed to enable attachment of the pocket to a host binding. D1 is narrow to allow for cocooning as shown in FIG. 5. D2 is short to allow for bottom edge indexing of and enclosing cocoon as shown in FIG. 5. W1 is the width of a typical leaf and is less than W3, the distance from the tab edges to the holes, 8. W2 is the width of the base panel 1a.

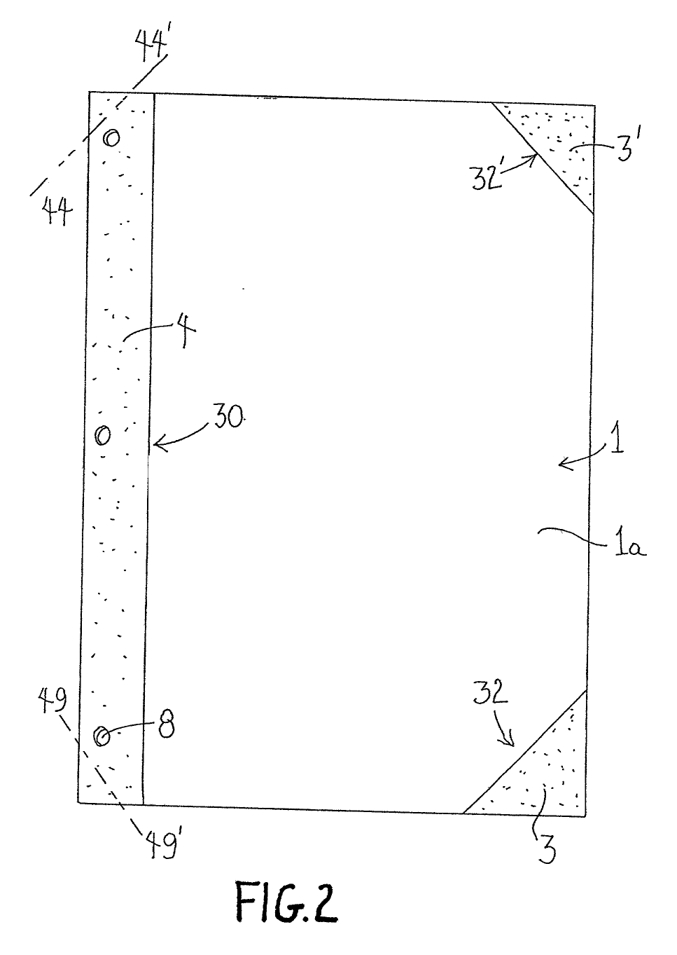

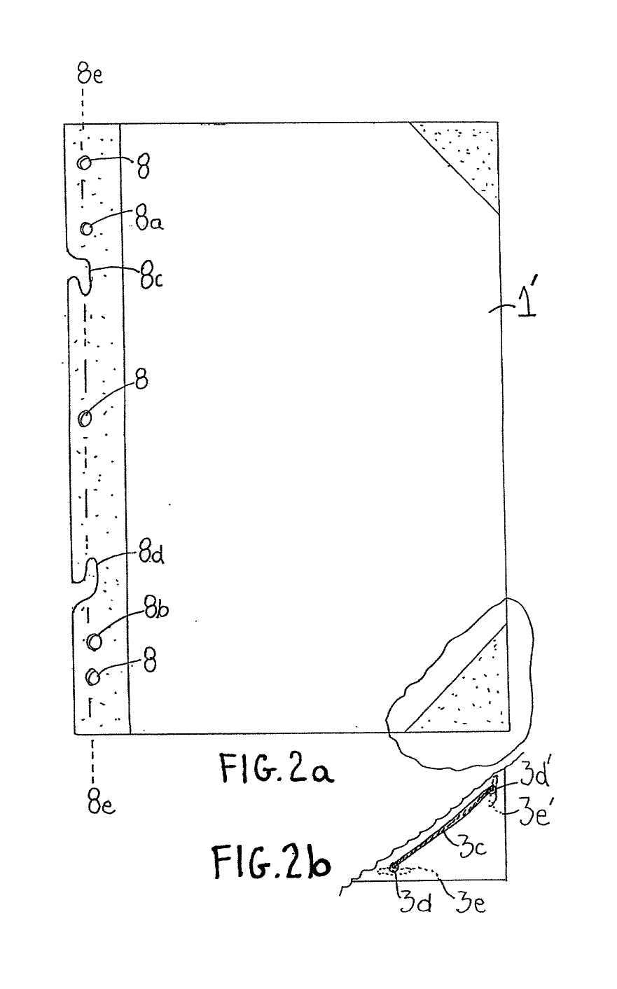

FIG. 2 Shows the front view of the pocket,1, having back or base panel 1a, with the leaves removed. The band 4 can be sealed onto the back panel 1a. Each material and means for forming the pocket portions would result in a different structural version of the same species of pocket. So corners 3′ and 3 can also be made integrally as part of a folding pattern off the base die, can be “welded on”, or can be attached as separate mini-tab pockets, for example. If this is done, it is desirable to attach the mini-tab pocket which would be triangular in shape so that the base panel 1a joins the interior corners of the mini-tab to allow a smooth base panel. The smooth base panel is needed under all pockets so that a first leaf can be slid into the pocket formation without a hitch. The diagonal cuts 44/44′ and/or 49/49′ are optional.

FIG. 2a Shows the front view of the pocket,1′, with the leaf removed where the pocket is shown to have alternative forms of mini-booking secondary binding structures. Hook cut pattern 8c/8d can be used with an elastic band to group pockets of this type into batches. Alternatively, one or both of holes 8a/8b could be used with one or two fasteners such as butterfly clips, to group batches of pockets. Either one or both kinds of “secondary binding structures” can be present, or any other similar kind of structure to allow grouping of pockets without a host ring binder, and still be in the scope of this invention.

FIG. 2b Shows an alternative corner formed from an elastic band, 3c, with two clips 3e and 3e′ affixed at each end thereof, and inserted into respective holes, 3d′ and 3d, diagonally punched at a distance substantially the length of the elastic band, away from each other. The band is stretched to latch over corners of leaves inserted below.

FIG. 3 Shows an unfolded view of one form of construction having dual corner tab portions, 3a′/3b′ and 3a/3b which each combine to form the corner pockets. The tabs may be “welded” together to make a triangular pocket or can have adhesive on either portion or both, for attachment. The band, 4 is shown as being formed by folding edge 57 over line 58 to place the holes symmetrically one on top of the other. The holes can be punched after ward. Tabs 9 and 9′ have adhesive 61 for bonding the tabs respectively to the back portion of the panel 1a, leaving a pocket, 30, formed thereunder, and forming a band as a section of material spanning the height of the base panel 1a. Each of the tabs has an optional expansion area shown as 91, 93, 94, 55′, 55″, and 95. The adhesive 61′ is used to seal the tabs 3 and 3b′ onto 3a and 3a′.

FIG. 3a Shows an alternative corner construction with a band strip 3a″, formed by a strip which is folded over edge 90′, and adhesively attached by adhesive 61″ on tab 3b′″, to the edge 55a, of the base panel, 1a′. Optional expansion hinge sections 55′″, and 55″″ allow for the band strip to accept a larger number of leaf corners.

Therefore the corners each have “enclosures” which allow the leaf corners to be held securely but temporarily. The rubber band, strip band, corner pocket die cut patterns each showing examples of corner enclosures which enclosures may be formed by similar construction and still be within the scope of this invention.

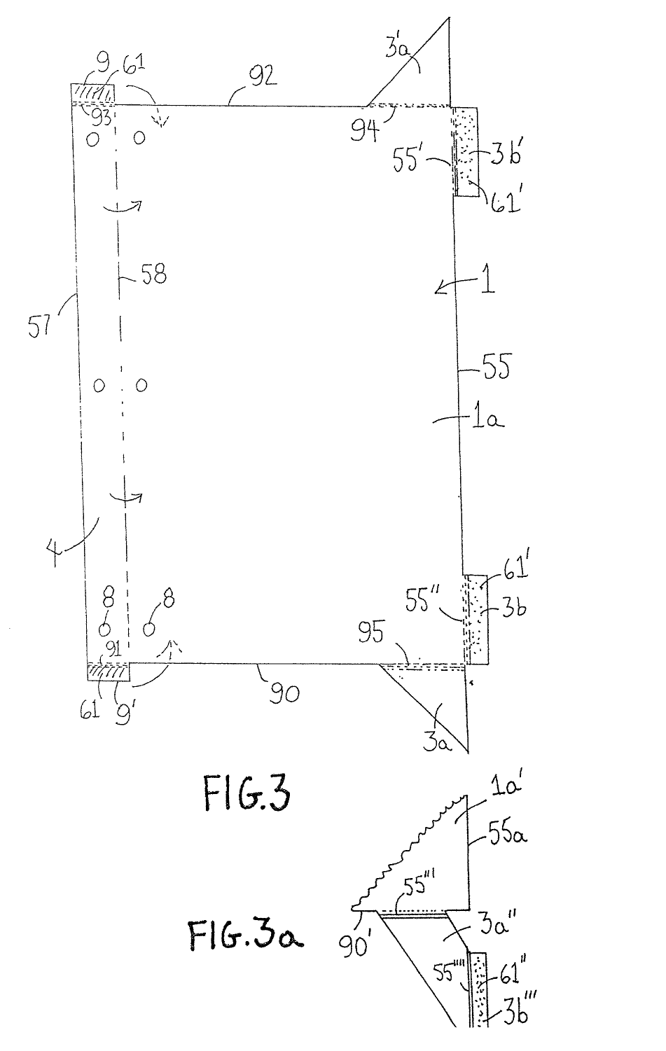

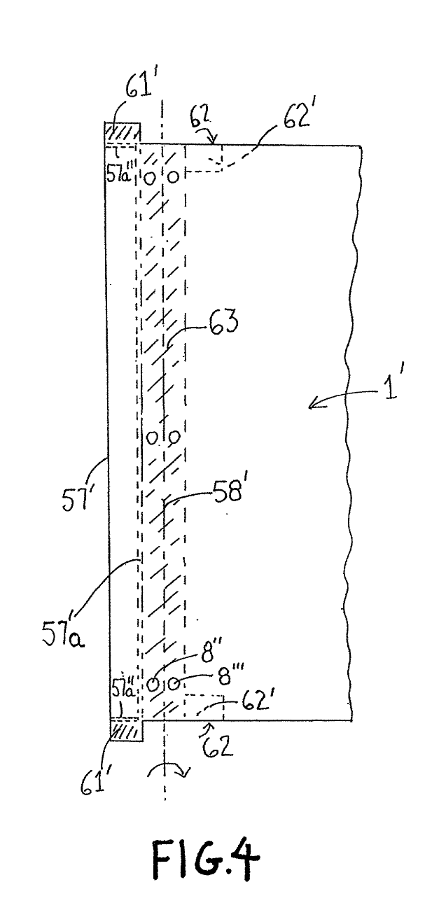

FIG. 4 Shows the unfolded part of another form of construction of the binding edge of the pocket for holding the margin edge of the leaf to be held therein, where the symmetrical hole portion 8″ and 8′″, is adhesively attached with a span of adhesive 63 over the area which folds to form a sealed hole binding strip, from one side to the other and the band is formed adjacent thereto with edge 57′ forming the entry lip therefore. Expansion strip 57a′ allows for the band to hold a larger number of leaves, where 57a″ completes the expansion strip to allow uniform expansion of the band to occur. Here, the tabs have adhesive 61′ which attaches to portion of the back panel of 1′ at locations 62.

FIG. 5 Shows a perspective view of a host binder, 70, having a bottom edge 71, in which the pocket according to the invention,1, is shown inserted between the covers of an encasing pocket, 1a and where said distance d2 is set so as to permit the bottom edge of said book edged pocket to be retained substantially offset from said bottom edge of said ring binder. This demonstrates the formation of a cocoon, where the “book binding edged pocket” is categorized by the encasing dual pocket folder. The top or bottom horizontal edge of the binder can be the point of reference for the offset of the horizontal top or bottom edge of the book binding pocket, i.e. indexing of the enclosing cocoon and or the pocket itself can be on the top or bottom edge. The idea is to have the book binding pocket retain a standard leaf batch (typically 8½ by 11 in USA) and still have the pocket, when encased in a cocoon with an index tab fit within the foot print of a closed standard 3 ring binder. The notion of standard is general here and the intention is to have the pocket fit in the foot print of the host binder.

The pocket can be made from a card stock, optionally in colored form where each pocket in a set can be a different color.

The bonding step will depend on the material used. Special adhesive is needed for Tyvek for example. Cardstock can be glued with commonly known adhesives. Plastic material can be chemically bonded, heat treated to bond, or can have its molecules electrically stimulated to bond, In one instance molecules are caused to bond by heat caused from a chemical reaction, and in the others, the process of “melting” bonds the fiber or radio frequency sealing bonds the materials. The result of attaching achieves a common purpose. Instead of tabs 9 and 9′, other methods can be employed as have been detailed. The edge which those tabs close can also be “fastened” by staples, stitching, or other similar methods to close, for example.

The application of this pocket and, in particular, the set of pockets taken together, is to enable a batching of record information about a variety of categories, each pocket according to the invention holds leaves, and where the state of “order” of the leaves in each pocket, can be marked by the manner in which the corners opposing the margin edge of the leaf are positioned with respect to the pockets subpocket portions.

In FIG. 2, optional angle cuts 44/44′, and 49/49′, allow for the use of this pocket in a ring binder and enable the pocket to miss the ring binder clips any cut pattern may be used to clear the tabs. The use of the book binding pocket within a cocoon, which is set within a ring binder is shown in FIG. 5. The hole distances d1 and d2 are particularly important for the preferred application of “cocooning”. In cocooning, the book binding pocket will be placed within another enclosing pocket. The enclosing pocket will be retained in a standard ring binder of any ring dimension. Therefore, the offset distance d1 should be “narrow”, allowing for retention of the pocket array as close to the ring binder as possible. Reinforcing the holes may be desirable to allow for the shortest realistic distance d1. Further d2 should be set to permit the bottom edge of the pocket 40 to reside on order of ½″ from the bottom of the host ring binder. For this reason, 44/44′ is slit to permit the top corner to turn freely past a host ring binders clips when present. The cocooning construction is fundamental to the application of this pocket configuration in what we are calling “Demand Paging” where one carries or moves around a set of leaves of paper which are related to “current transactions” and the objective for portability achieves the “10/90” rule where 10% of the “mission critical” information you need is available to you 90% of the time, in the cocoon configuration you have at your finger tips at that moment.

Demand paging allows leaves to move through the cocoon, and in particular the book binding pocket on an as needed basis, where as records recorded on the leaves“age” they can be moved in batches retained in their respective book binding pocket, to a respective archive for referential access. This movement can be effected by either lifting out the batches of leaves from the book binding pocket, or taking the book binding pocket with its leaves enclosed, and archiving the pocket batch. In the first case, demand paging occurs by shuffling the batch out of its pocket and performing a secondary binding operation. In the [former]later case, the pocket is detached from it's primary binding and attached in some fashion whether by piling or some other form of more secure binding, to a secondary binding.

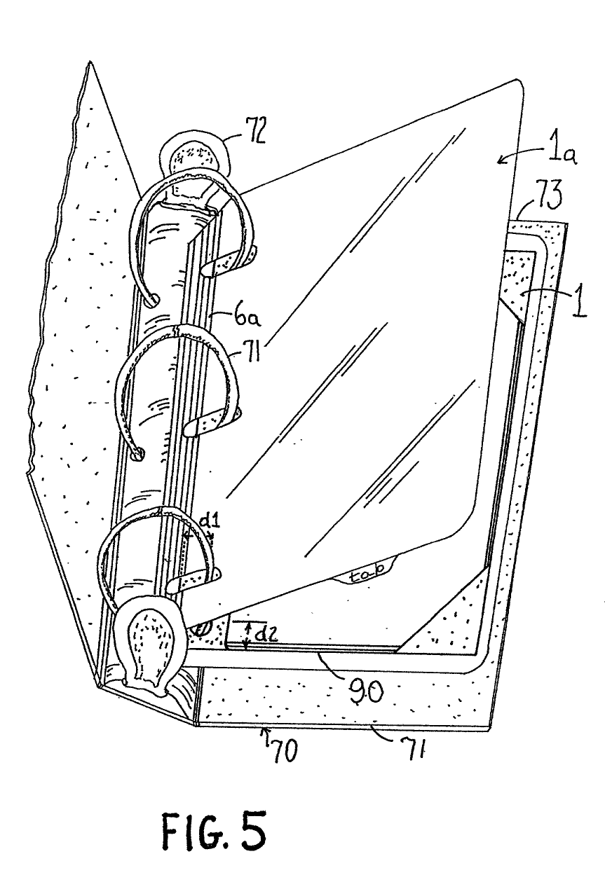

An additional group of preferred embodiments and alternative embodiments now follow. In FIG. 6, strip 102 and corner tabs 103 and 103′ are folded over. Glue beads 110,111,110′, and 111′ are dropped and panel tabs 100, 101 and 100′, 101′ are folded over onto the glue and sealed. This formation is ideal for construction in paper board, where the glue is similar to a hot melt glue, and where the pattern is plow folded on opposing edges, bumped and turned, then glued and plow folded in line. Strip 102 forms the book binding edge. Tab portions such as 100 are visible on the front face of the pocket. Hole 106 on the backing panel is slightly oversized to compensate for any tolerance in folding if the holes are in the die. If the holes are punched, this type of formation is not applicable. The tab 5 may be glued in the alternative pattern thereby hiding the tabs. This would be done in such a way to prevent impedance to sheet insertion. Recessed tabs would allow this.

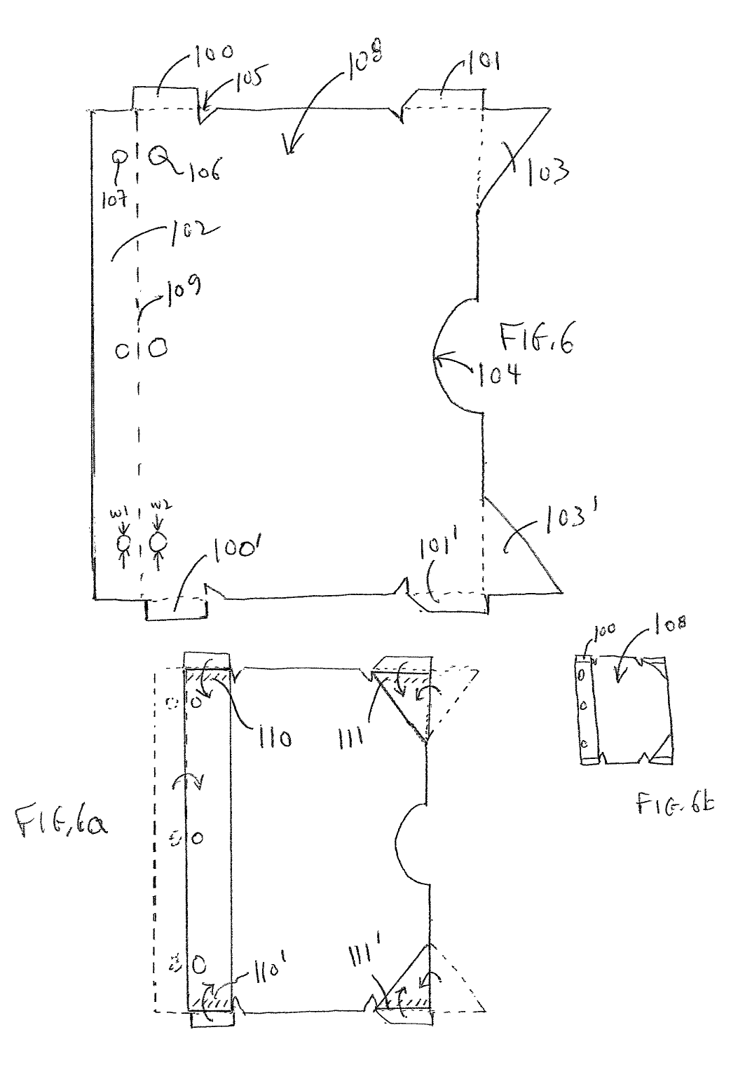

FIG. 7 has a hole pattern 66,66′,67 formed in a portion of the book binding edge reinforced by adhesive 68. When folded over, adhesive 68 forms a reinforcing strip portion while leaving the pocket portion 69 open.

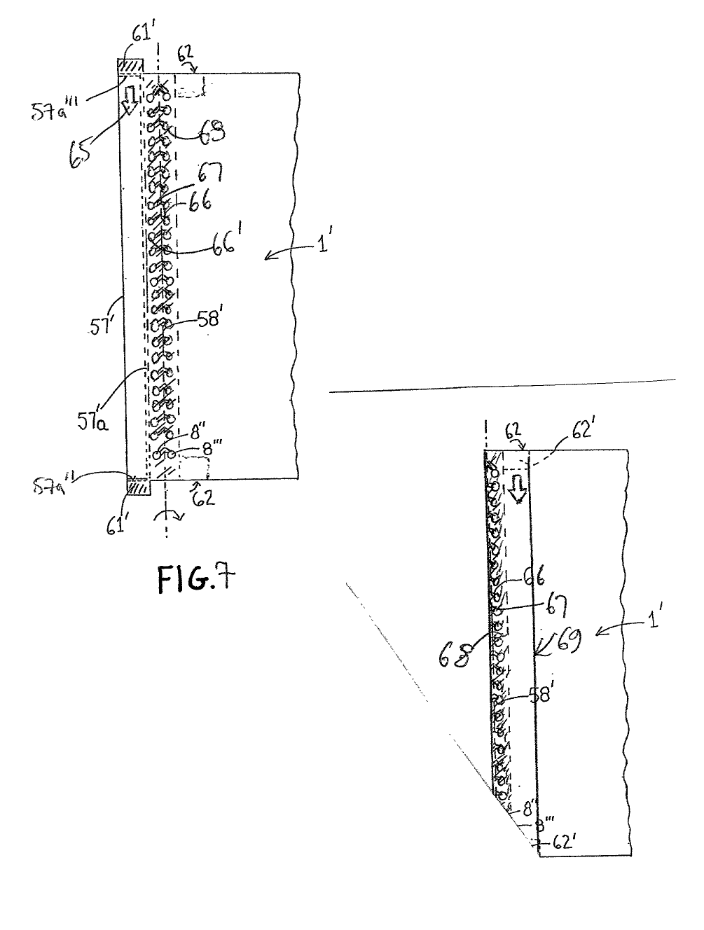

FIG. 8 uses picture frame portion tabs 202,203, and 204 to form a set of hidden folds using only 3 glue strips. The panel 200 is flipped up on top of the frame and the glue is applied and the tabs folded and sealed. Alternatively, RF or other bonding means can be employed depending on the material used.

FIG. 8A shows glue portions 208, 209, and 210. FIG. 8b shows the completed pocket 211.

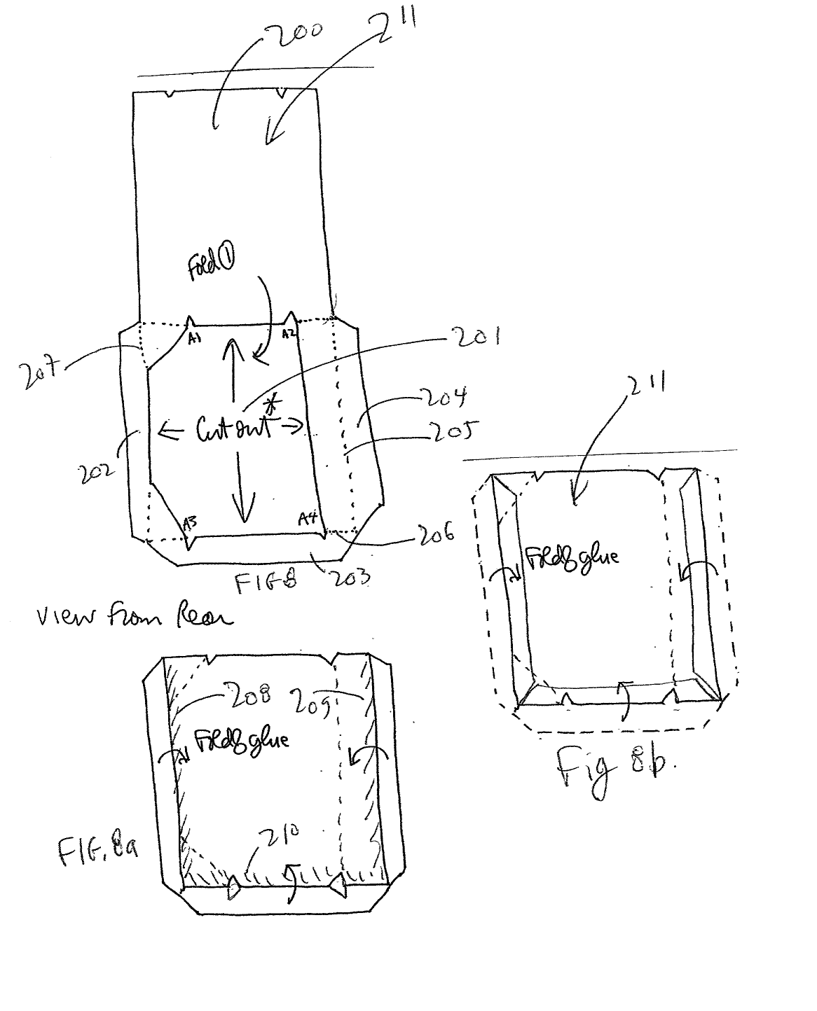

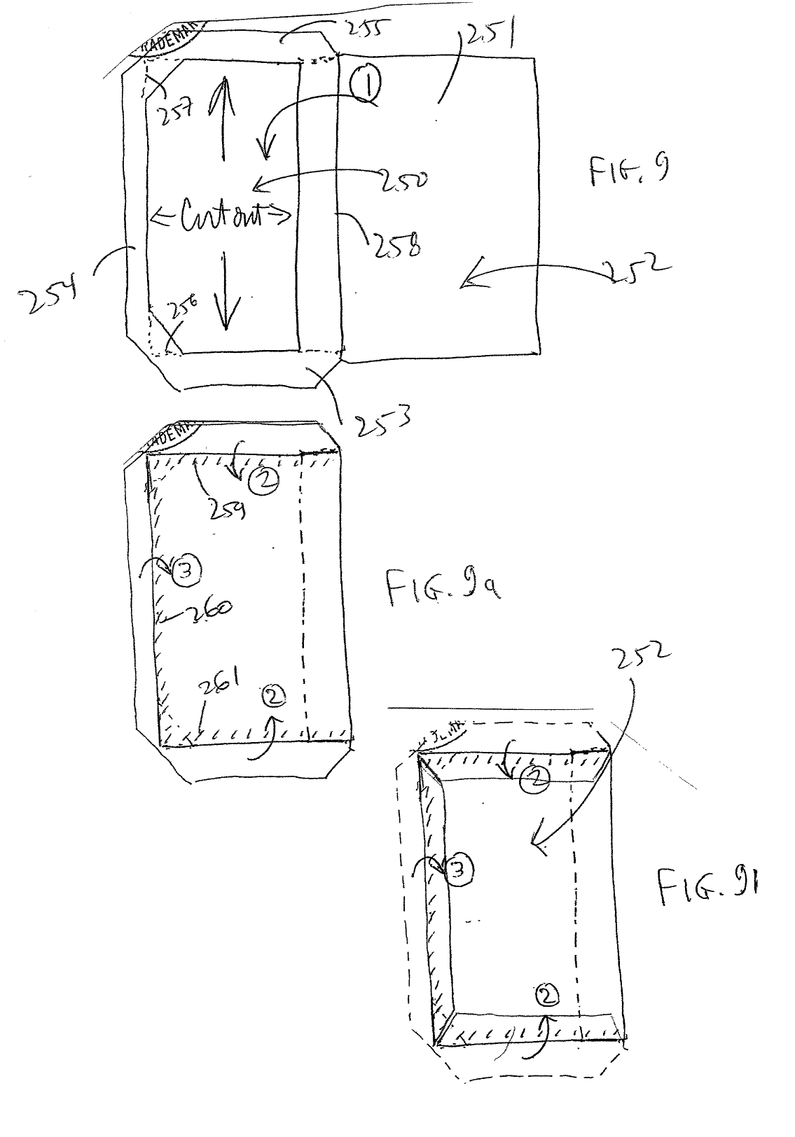

In FIG. 9, the formation is similar to FIG. 8 except that the panel is folded over the margin binding strip edge. Panels 255, 254, and 253 are folded over onto adhesive portions 259, 260, and 261. FIG. 9b shows the back portion of pocket 252 with three folded and hidden tabs.

In FIG. 10, margin binding strip edge 270′ is formed in two substantially adjacent portions 270 and 271. Slot 270″ can be made larger while still retaining the properties of holding down the margin edge of leafs retained.

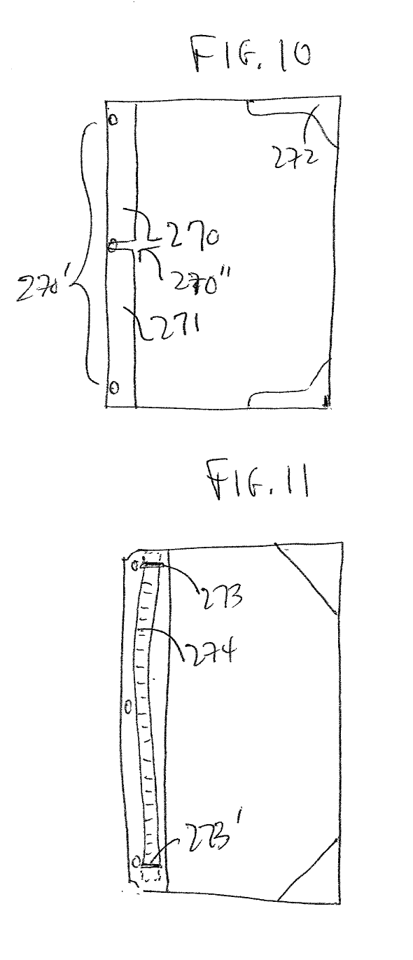

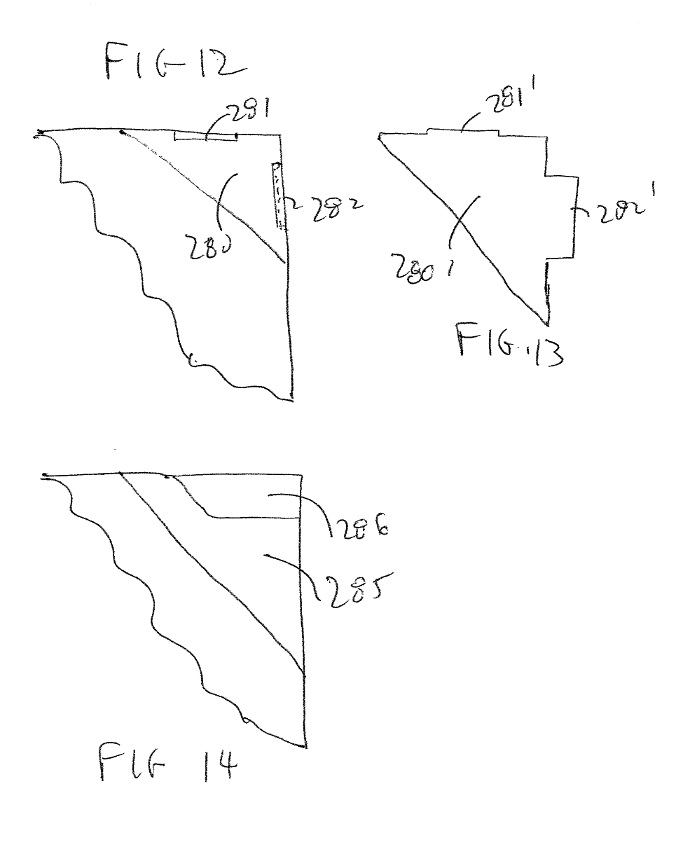

FIG. 11 has slots 273 and 273′ receiving label strip 274.

FIG. 132 has lock slot 281 receive lock table 281′ of FIG. 13, and label slot 282 receive label portion 282′ of 280′. One slot may be used or 2 label slots may be used.

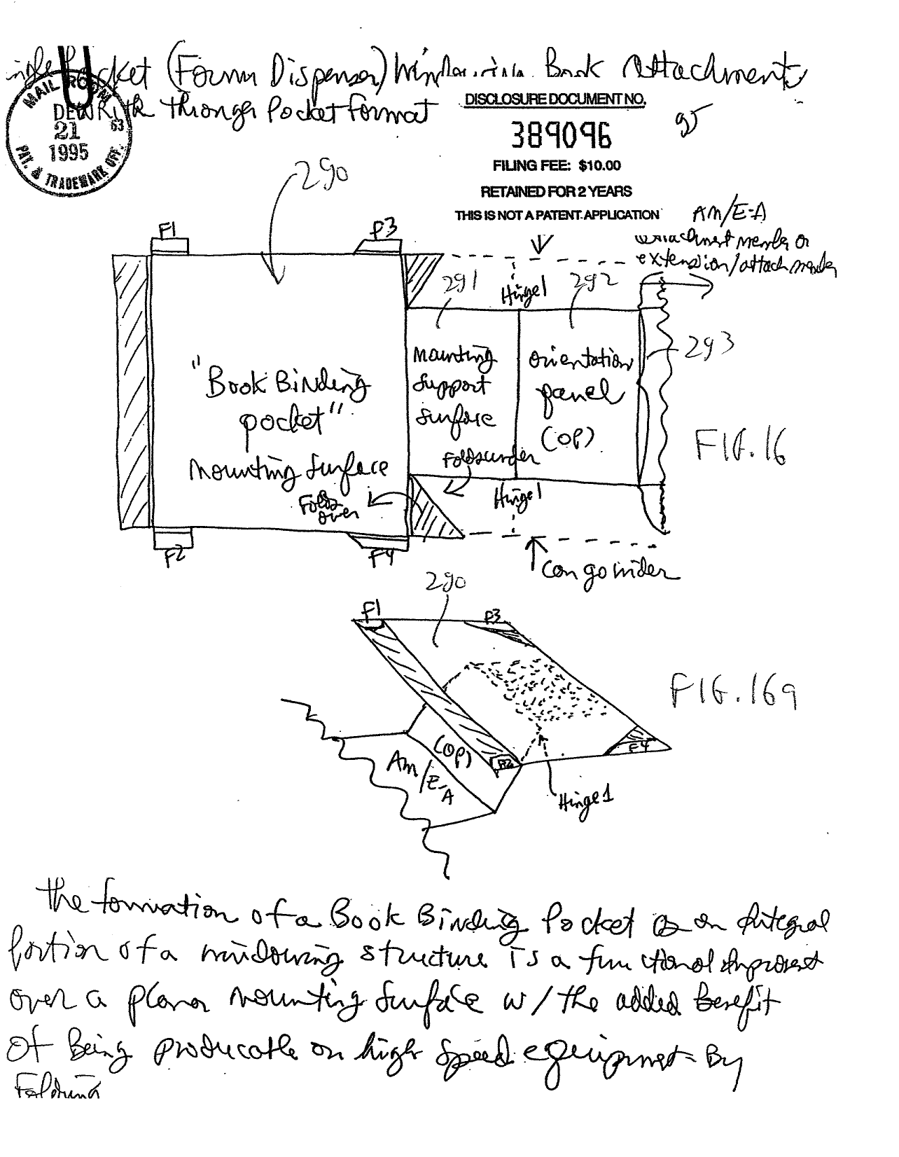

FIG. 14 features a cut out portion 286 in corner 285. This can be done on top and or bottom corners and on any portion of the corner pocket to permit “write through labeling” directly onto the portion of the face sheet retained thereunder.

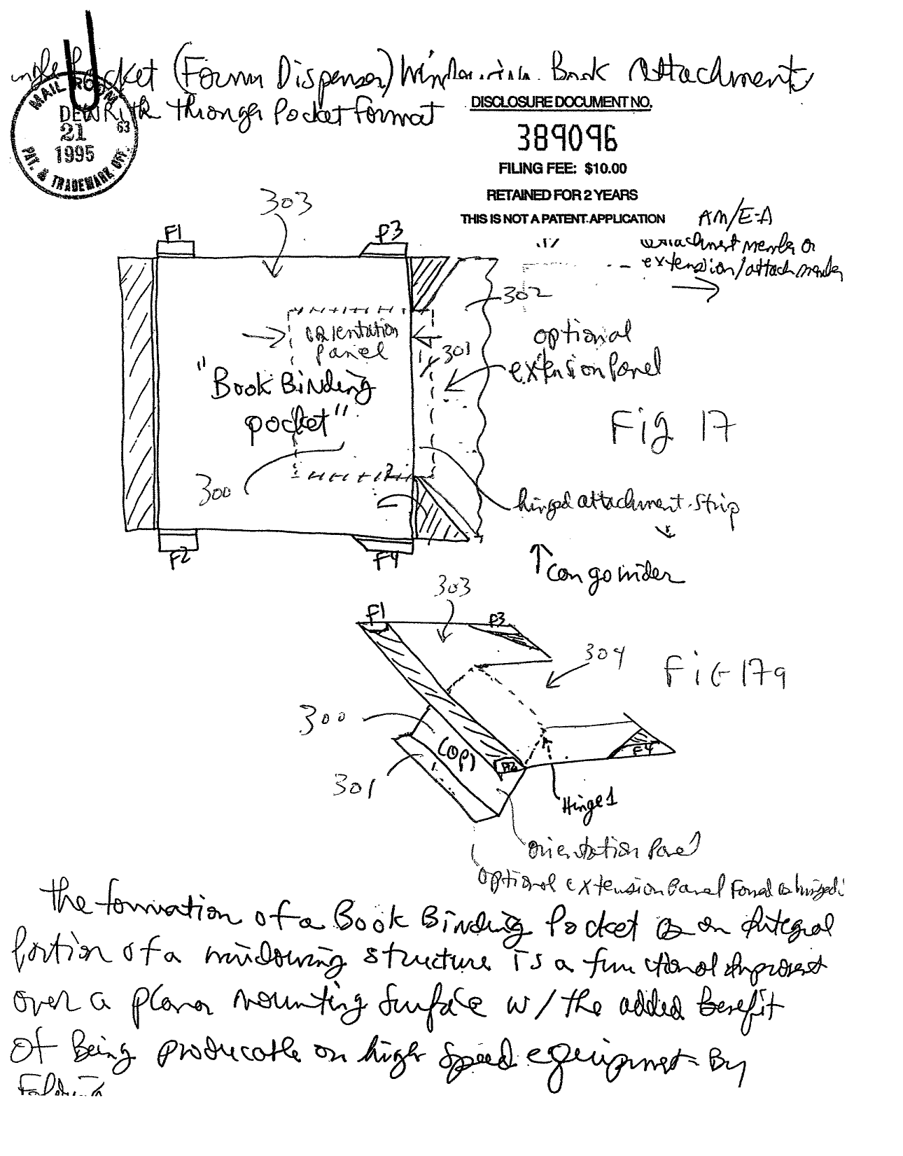

In FIG. 16, and integral section of panels 281 and 292 and optionally 293 are formed off backing panel 290 for making a windowing book binding pocket attachment. FIG. 16A pocket 290 is the assembled figure with hinge 1 forming between opposing edges of the book binding pocket.

In FIG. 17, the orientation panel 300 is formed directly in the back panel of pocket 303, formed as a portion of panel 300. Hinged binding strip 301 would be used to retain the assembly to a host.

One skilled in the art will appreciate that the present invention can be practiced by other than the embodiments described, which are presented for the purpose of illustration and not of limitation, and the present invention is limited only by the claims which follow.

What is claimed is:

1. A binder pocket for a ring binder, for viewing leaves which may be held within by using a book like page turning operation, said binder pocket therefore a book binding pocket, said book binding pocket formed from a single sheet of flexible, foldable material, for holding a leaf having a set of perimeter features including opposing top and bottom height edges and opposing side width edges, a predetermined height, a predetermined width, said leaf further comprising a margin portion along one of said width edges as well as a face surface for writing on, said book binding pocket comprising:
a base panel, substantially rectangular, having perimeter features including opposing corners, opposing height edges, opposing width edges, said opposing width edges comprising a book edge and a corner binding edge, a predetermined base panel height, and a predetermined base panel width, said predetermined base panel width being said pocket width,
said base panel further having a book binding structure formed along said book edge wherein, said book binding structure comprises a band having dimensions including a predetermined height and a predetermined width said predetermined width substantially the sum of a binding region of said book binding structure and the width of the margin portion of a leaf to be held within, said predetermined height substantially spanning said book edge, for holding said margin portion of said leaf thereunder, said band being closed along three sides and further having perimeter features including opposing top and bottom ends, a top tab portion, a bottom tab portion, and opposing inner and outer edges, said band being attached to said base panel along a first coterminous edge formed by said book edge of said base panel and said outer edge of said band, said band further being attached along a second and a third edge, said top end and said bottom end, wherein said band attached to said base panel along said top end and said bottom of said band is attached at said top end and said bottom end of said base panel by means of said top and said bottom tab portions, where said top band end is adhesively attached by said top tab structure to said base panel, said attachment forming a permanent closure between said base panel and said band top end and further, said band is adhesively attached at said bottom end by means of said bottom tab structure, said attachment forming a permanent closure between said base panel and said band bottom end, for forming a first enclosed pocket between said band and said base panel, said first enclosed pocket so formed being open along said inner edge of said band, and wherein, said first enclosed pocket further comprises a binding region comprising a plurality of holes set a predetermined distance from said book edge, said plurality of holes further being placed a predetermined distance from said corner pocket edge, such that when a leaf is placed in said book binding pocket with a first edge of said leaf substantially coterminous with said corner pocket edge, said predetermined distance of said plurality of holes from said corner pocket edge is greater than said predetermined width of said leaf for holding, said book binding pocket further comprising
at least one of a top and bottom corner pockets formed on adjoining corners of said base panel along said corner pocket edge, said each of said at least one of said top and bottom corner pockets having three edges including two adjacent edges attached to said base panel and an open lip edge there between for forming each corner pocket closed along said two adjacent edges and open along said open lip edge,
such that when said leaf for holding in said book binding pocket is inserted therein for holding, with the edge of said leaf opposing said margin edge of said leaf, tucked into at least one of said corner pockets, with said leaf edge opposing said leaf margin edge substantially adjacent said corner pocket edge, said leaf margin edge is contained under said band with said plurality of holes remaining unobstructed by said margin edge of said leaf, said plurality of holes thereby permitting attachment there through to a host ring, such that said leaf has secure entry in said book binding pocket within said book binding structure and at least one of said corner pockets, with said leaf face surface substantially exposed and accessible for direct writing, for turning as a page in a book from the edge opposing the leaf margin edge when such edge is relieved from said corner pocket, and for continuous shuffling one leaf below the next into the book binding pocket without having to open the rings of a binder when said booking binding pocket is so contained by a ringed binder through its plurality of holes.

2. A binder pocket for a ring binder, for viewing leaves which may be held within by using a book like page turning operation, said binder pocket therefore a book binding pocket, said book binding pocket formed from a single sheet of flexible, foldable material, for holding a leaf having a set of perimeter features including opposing top and bottom height edges and opposing side width edges, a predetermined height, a predetermined width, said leaf further comprising a margin portion along one of said width edges as well as a face surface for writing on, said book binding pocket comprising:
a base panel, substantially rectangular, having perimeter features including opposing corners, opposing height edges, opposing width edges, said opposing width edges comprising a book edge and a corner binding edge, a predetermined base panel height, and a predetermined base panel width, said predetermined base panel width being said pocket width,
said base panel further having a book binding structure formed along said book edge wherein, said book binding structure comprises a band having dimensions including a predetermined height and a predetermined width said predetermined width substantially the sum of a binding region of said book binding structure and the width of the margin portion of a leaf to be held within, said predetermined height substantially spanning said book edge, for holding said margin portion of said leaf thereunder, said band being closed along three sides and further having perimeter features including opposing top and bottom ends,and opposing inner and outer edges, said base panel further comprising a top tab portion and a bottom tab portion said top tab portion being attached to said base panel along said base panel top height edge substantially at said book edge, said bottom tab portion being attached to said base panel along said base panel bottom height edge substantially at said book edge, said band being attached to said base panel along a first coterminous edge formed by said book edge of said base panel and said outer edge of said band, said band further being attached along a second and a third edge, said top end and said bottom end, wherein said band attached to said base panel along said top end and said bottom of said band is attached to said top height end and said bottom height end of said base panel by means of said top and said bottom tab portions, where said top band end is adhesively attached at said top end to said base panel by said base panel top tab structure, said attachment forming a permanent closure between said base panel and said band top end and further, said bottom band end is adhesively attached at said bottom end by means of said base panel bottom tab structure, said attachment forming a permanent closure between said bottom band end and said base panel bottom end, for forming a first enclosed pocket between said band and said base panel, said first enclosed pocket so formed being open along said inner edge of said band, and wherein, said first enclosed pocket further comprises a binding region comprising a plurality of holes set a predetermined distance from said book edge, said plurality of holes further being placed a predetermined distance from said corner pocket edge, such that when a leaf is placed in said book binding pocket with a first edge of said leaf substantially coterminous with said corner pocket edge, said predetermined distance of said plurality of holes from said corner pocket edge is greater than said predetermined width of said leaf for holding, said book binding pocket further comprising
at least one of a top and bottom corner pockets formed on adjoining corners of said base panel along said corner pocket edge, said each of said at least one of said top and bottom corner pockets having three edges including two adjacent edges attached to said base panel and an open lip edge there between for forming each corner pocket closed along said two adjacent edges and open along said open lip edge,
such that when said leaf for holding in said book binding pocket is inserted therein for holding, with the edge of said leaf opposing said margin edge of said leaf, tucked into at least one of said corner pockets, with said leaf edge opposing said leaf margin edge substantially adjacent said corner pocket edge, said leaf margin edge is contained under said band with said plurality of holes remaining unobstructed by said margin edge of said leaf, said plurality of holes thereby permitting attachment there through to a host ring, such that said leaf has secure entry in said book binding pocket within said book binding structure and at least one of said corner pockets, with said leaf face surface substantially exposed and accessible for direct writing, for turning as a page in a book from the edge opposing the leaf margin edge when such edge is relieved from said corner pocket, and for continuous shuffling one leaf below the next into the book binding pocket without having to open the rings of a binder when said booking binding pocket is so contained by a ringed binder through its plurality of holes.
